(19) United States
(12) Patent Application Publication
(10) Pub. No.: US 2007/0130754 A1
(43) Pub. Date: Jun. 14, 2007

(54) Laser ablation prototyping of RFID antennas

(76) Inventor: Michael Fein, Ann Arbor, MI (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/300,648

(22) Filed: Dec. 14, 2005

(51) Int. Cl. H01P 11/00; G08B 13/14; G06F 17/50

(52) U.S. Cl. 29/600; 340/572.7; 716/1

(57) ABSTRACT

A laser ablation radio frequency identification (RFID) antenna prototyping system includes an antenna design module, an ablation laser, and a laser driver. The antenna design module includes design parameters for an RFID antenna prototype. The laser driver communicates with the antenna design module and the ablation laser. The laser driver uses the design parameters to direct the ablation laser to heat a portion of a conductive ink layer that is formed on a substrate.

### FIELD OF THE INVENTION

The present invention relates to radio frequency identification (RFID) antennas, and more particularly to a method of producing prototype RFID antennas.

### BACKGROUND OF THE INVENTION

Integrated circuits (ICs) are the basic building blocks that are used to create electronic devices. Continuous improvements in IC process and design technologies have led to smaller, more complex, and more reliable electronic devices at a lower cost per function. As performance has increased and size and cost have decreased, the use of ICs has expanded significantly.

One particular type of IC that would benefit from inexpensive mass production involves the use of radio frequency identification (RFID) technology. RFID technology incorporates the use of electromagnetic or electrostatic radio frequency (RF) coupling. Traditional forms of identification such as barcodes, cards, badges, tags, and labels have been widely used to identify items such as access passes, parcels, luggage, tickets, and currencies. However, these forms of identification may not protect items from theft, misplacement, or counterfeit, nor do they allow “touch-free” tracking.

More secure identification forms such as RFID technology offer a feasible and valuable alternative to traditional identification and tracking. RFID does not require physical contact and is not dependent on line-of-sight for identification. RFID technology is widely used today at lower frequencies, such as 13.56 MHz, in security access and animal identification applications. Higher-frequency RFID systems ranging between 850 MHz and 2.5 GHz have recently gained acceptance and are being used in applications such as vehicular tracking and toll collecting, and in business logistics such as manufacturing and distribution.

Traditionally, antennae for RFID tags are designed primarily to function as collectors of RF energy to promote tag function. A printing process is used to print conductive traces on a substrate to form a functional electronic structure such as an RFID antenna. The RFID antenna absorbs, couples with, and/or reflects radio frequency signals from a transmitter and provides a signal and power to an attached integrated circuit.

RFID antenna prototypes are necessary to verify computer simulation results, to measure antenna properties, and to test antenna performance. Several prototypes are typically required to optimize RFID antenna performance. The ability to quickly create accurate RFID antenna prototypes may allow for samples to be delivered to a customer expeditiously and can substantially reduce product development time and cost.

In one method, RFID antenna prototypes are created by painting designs with a brush or stencil on the substrate. However, painting the design on the substrate limits resolution of the design and offers poor control of ink film thickness.

In another method, RFID antenna prototypes are created by cutting designs out of a conductive ink layer on the substrate using a blade. However, cutting designs with a blade limits resolution and offers poor physical stability of design.

In yet another method, RFID antenna prototypes are created by proofing the design with a screen proofer, a flexo proofer, or a gravure proofer. However, creating prototypes using proofing techniques is typically time consuming and expensive.

### SUMMARY OF THE INVENTION

A laser ablation radio frequency identification (RFID) antenna prototyping system according to the present invention includes an antenna design module, an ablation laser, and a laser driver. The antenna design module includes design parameters for an RFID antenna prototype. The laser driver communicates with the antenna design module and the ablation laser. The laser driver uses the design parameters to direct the ablation laser to heat a portion of a conductive ink layer that is formed on a substrate.

In other features, the laser ablation RFID antenna prototyping system includes a removal device that removes the heated portions of the conductive ink layer using an adhesive surface and/or a pressurized gas.

In yet other features, the laser ablation RFID prototyping system is configured based on power and speed, pulses, and/or height. The power is greater than an ablation threshold that occurs when chemical bonds of the conductive ink layer begin to breakup. The power is also less than a cutting threshold that occurs when the laser cuts through the substrate.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a functional block diagram of a RFID antenna prototype system according to the present invention;

FIG. 2A is an exemplary graphical display of design parameters associated with the RFID antenna prototype system;

FIG. 2B is an exemplary graphical display of laser configuration parameters associated with the RFID antenna prototype system;

FIG. 3A illustrates an exemplary conductive ink layer formed on a substrate;

FIG. 3B illustrates ablated portions created in the conductive ink layer with the laser;

FIG. 3C illustrates an RFID antenna prototype after the ablated portions are removed; and

FIG. 4 illustrates exemplary steps taken by the RFID antenna prototype system to create the RFID antenna prototype.

### DETAILED DESCRIPTION OF THE PREFERRED EMBODIMENTS

The following description of the preferred embodiment(s) is merely exemplary in nature and is in no way intended to limit the invention, its application, or uses. For purposes of clarity, the same reference numbers will be used in the drawings to identify similar elements. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

Laser ablation, in the broadest sense, is removal of material due to incident light. In most metals and glasses/crystals the removal is by vaporization of the material due to heat. In polymers the material can be removed by exposure to laser emissions at a wavelength where the polymer strongly absorbs photons. Ablation occurs when chemical bonds are broken in the polymer. In this manner, the ablated area may be easily removed due to a chemical dissolution of the polymer.

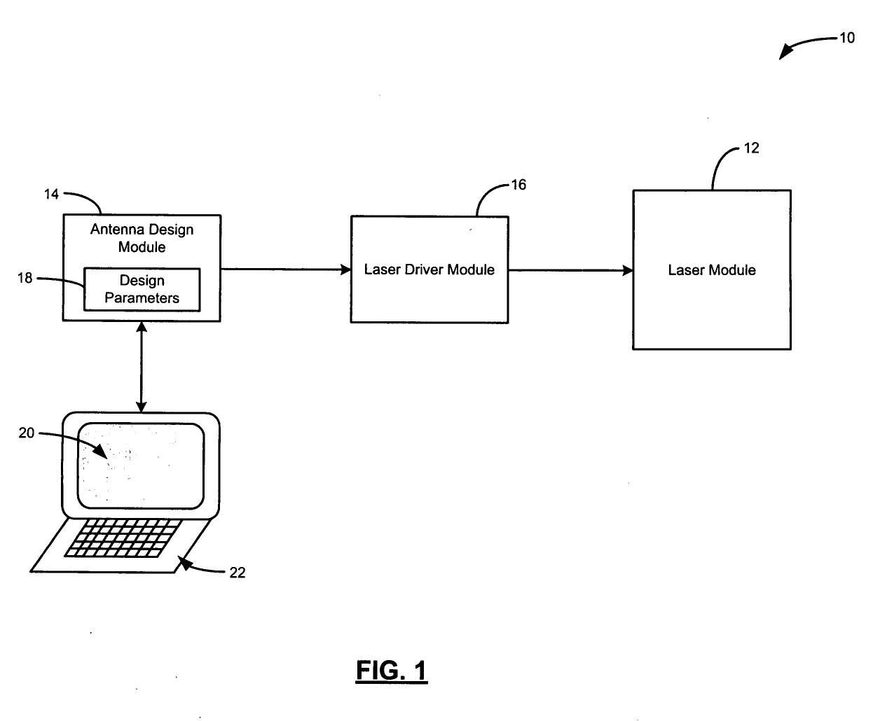

Referring now to FIG. 1, a radio frequency identification (RFID) antenna prototype system 10 that uses laser ablation includes a laser module 12, an antenna design module 14, and a laser driver module 16. The laser module 12 uses a laser (not shown) to ablate conductive ink. The laser is preferably a carbon dioxide laser capable of generating up to 25 Watts of power with a beam width of 70 microns (10⁻⁶ meters). The laser can be configured to ablate conductive ink by adjusting power, speed, pulses, and height. At low power, the laser has no visible effect on the conductive ink. However, as the power increases an ablation threshold is reached. When the power reaches the ablation threshold the chemical bonds of the conductive ink begin to breakup. Since different types of conductive inks have different chemical compositions, each type of conductive ink may have a unique ablation threshold. The ablation threshold may further be affected by the thickness of conductive ink applied to a substrate holding the ink and the chemical composition of the substrate. A cutting threshold is reached when the power of the laser is increased to a level capable of cutting through a substrate holding the conductive ink.

To ablate conductive ink, the laser should be set above the ablation threshold and below the cutting threshold. For example to ablate a 3-5 micron thick silver conductive ink the power may be 2 Watts and the pulses may be 200 pulses per inch. The laser may also be configured to cut through a substrate holding the conductive ink when the power exceeds the cutting threshold. For example to cut the substrate the power may be 5.75 Watts and the pulses may be 250 pulses per inch.

The antenna design module 14 is used to design an RFID prototype. More specifically, design parameters 18 may be configured that describe a desired antenna pattern. The antenna pattern is indicative of portions of conductive ink to be removed from an initial block of conductive ink. The laser driver module 20 directs the laser to heat the conductive ink according to the design parameters 18. In this manner, the laser ablates portions of the conductive ink according to the design parameters 18. When the ablated portions are removed, the remaining conductive ink forms the desired antenna pattern.

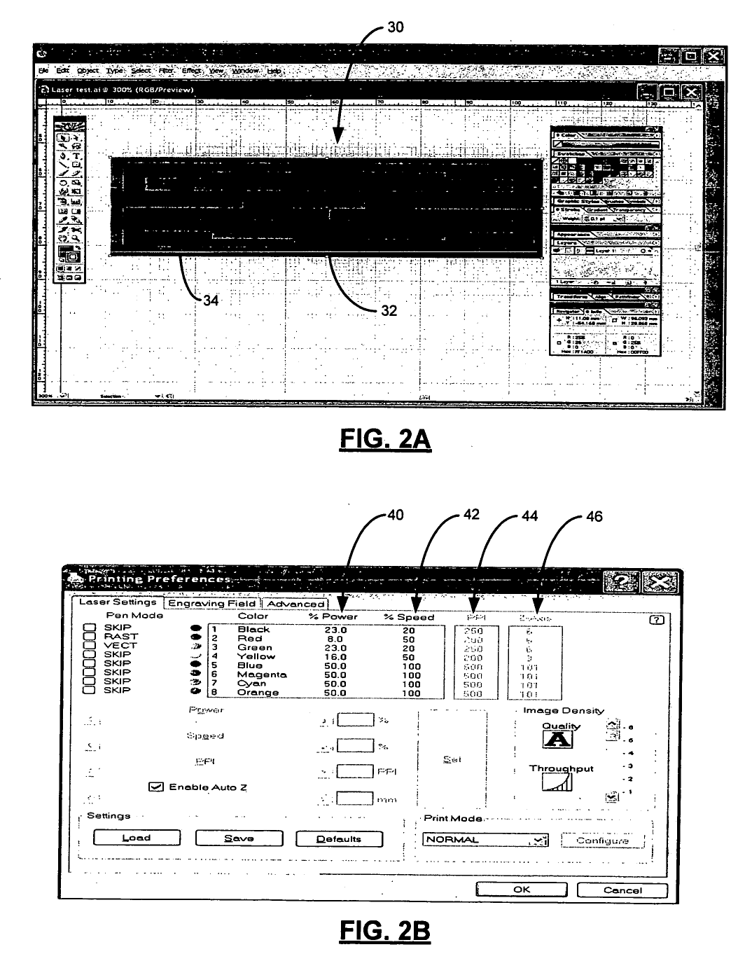

A graphical user interface (GUI) 20 may communicate with the antenna design module 14. For example, the GUI 20 and/or antenna design module 14 may reside on a computing device such as a laptop computer 22. The antenna design parameters 18 are stored in memory of the laptop computer 22. The GUI 20 may display the design parameters 18 as a graphical layout 30 as shown in FIG. 2A. The portions to be ablated may be represented by a first color 32 while the remaining portions may be represented by a second color 34. For example, the different colors represent different laser parameters that are used for each colored portion.

The GUI 20 may also display the laser configuration as shown in FIG. 2B. The first and second colors 32, 34 may be displayed along with a respective power, speed, pulse, and height. The power for each color is displayed at 40, the speed is displayed at 42, the pulses are displayed at 44, and the height is displayed at 46.

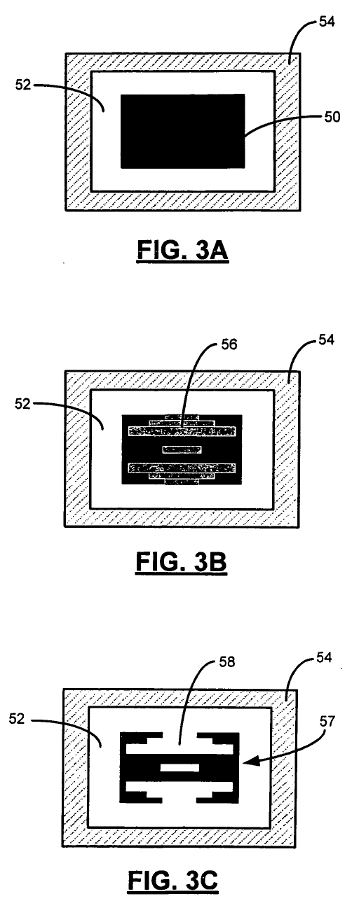

Referring now to FIG. 3A, a conductive ink layer 50 may be formed on a substrate 52 that is fixed to a planar surface 54. The planar surface 54 is preferably made of glass, however others surfaces may be used. The laser module 12 is configured to heat portions of the conductive ink layer 50 according to the design parameters 18. Chemical bonds breakdown in the heated portions of the conductive ink layer 50 creating an ablated area 56 as shown in FIG. 3B.

Although the ablated area 56 is no longer capable of bonding to the substrate 52, the residual conductive ink may require removal in order to create a RFID antenna prototype 57 as shown in FIG. 3C. A removal device having an adhesive surface (not shown) may be used to remove the residual conductive ink creating a cleared area 58. More specifically, the adhesive surface may be applied to the conductive ink layer 50 and then removed. When the adhesive surface is removed, the residual conductive ink in the ablated area 56 adheres to the adhesive surface leaving behind a pattern in the conductive ink layer 50. For example, the adhesive surface may be a temporary adhesive tape such as Magic Tape manufactured by 3M.

Alternatively, the ablated area 56 may be removed by applying a pressurized gas, such as air, to the conductive ink layer 50. A force of the pressurized gas should be great enough to remove the residual conductive ink in the ablated area 56 without damaging the remaining conductive ink layer 50.

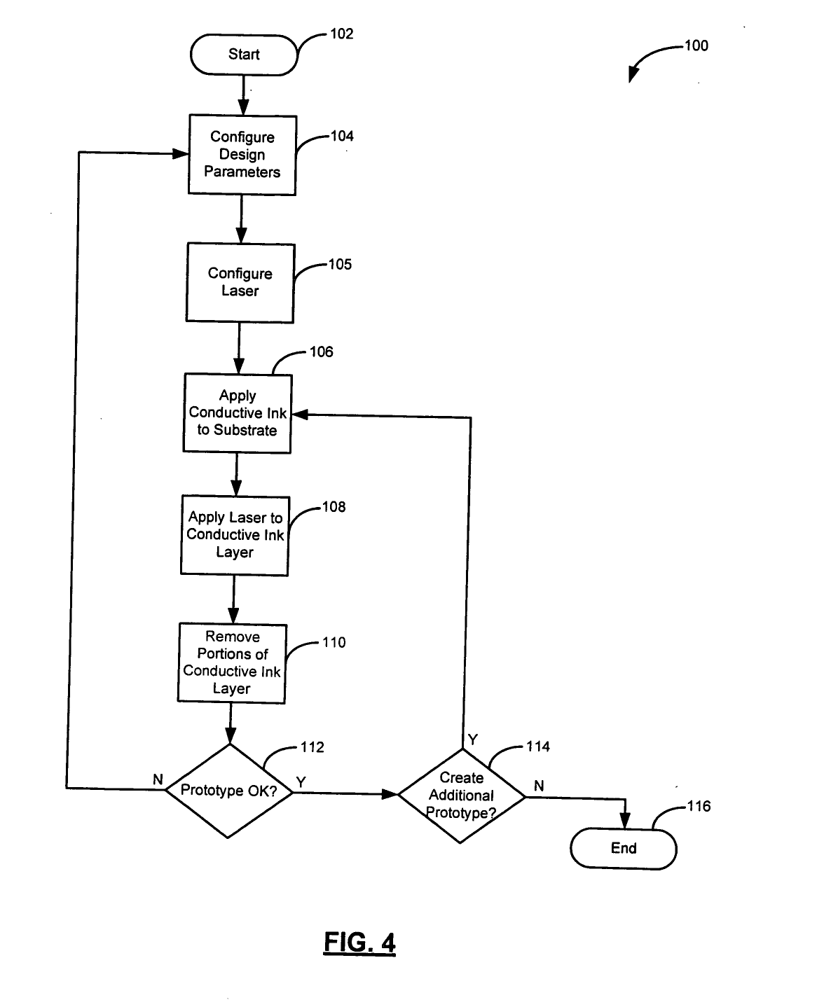

Referring now to FIG. 4, the RFID antenna prototype system 10 implements steps generally identified at 100. The process starts at step 102 when a user desires to create the RFID antenna prototype 57. In step 104, the user configures the design parameters 18 to describe the RFID antenna prototype 57 using the antenna design module 14.

The power, speed, pulses, and height of the laser are configured in step 105. More specifically, the power is set greater than the ablation threshold and less than the cutting threshold for the portion of the conductive ink layer 50 that is to be removed. In addition, the power may be set greater than the cutting threshold to cut an outer footprint of the RFID antenna prototype 57 facilitating removal. The height is preferably adjusted to achieve a desired focal point on the conductive ink layer 50 and thus varies in accordance with the thickness of the planar surface 54.

In step 106, the conductive ink layer 50 is applied to the substrate 52. The laser driver module 16 directs the laser module 12 to ablate portions of the conductive ink layer 50 according to the design parameters 18 in step 108. In step 110, the ablated area 56 is removed from the conductive ink layer 50 to create the RFID antenna prototype 57. For example, a removal device with an adhesive surface and/or a pressurized gas is used to remove the ablated area 56 as described in FIG. 3C.

When the ablated area 56 is removed from the conductive ink layer 50, the user may determine whether the RFID antenna prototype 57 is acceptable in step 112. The RFID antenna prototype 57 may be acceptable when the remaining pattern is within a predetermined design specification and/or when its test performance is within a predetermined performance specification. If the RFID antenna prototype 57 is not acceptable, the process returns to step 104 to configure the design parameters 18. If the RFID prototype 57 is acceptable, the user may determine whether an additional RFID prototype 57 is desired in step 114. If another RFID antenna prototype 57 is desired, the process returns to step 106, otherwise the process ends in step 116.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A laser ablation radio frequency identification (RFID) antenna prototyping system, comprising:
a substrate;
a conductive ink layer formed on said substrate;
an antenna design module that includes design parameters for an RFID antenna prototype;
an ablation laser; and
a laser driver that communicates with said antenna design module and directs said ablation laser to heat a portion of said conductive ink layer according to said design parameters.

2. The laser ablation RFID antenna prototyping system of claim 1 further comprising a removal device that removes said portion of said conductive ink layer.

3. The laser ablation RFID antenna prototyping system of claim 2 wherein said removal device uses an adhesive surface to remove said portion of said conductive ink layer.

4. The laser ablation RFID antenna prototyping system of claim 2 wherein said removal device removes said portion with a pressurized gas.

5. The laser ablation RFID antenna prototyping system of claim 2 wherein said ablation laser is configured based on power and a least one of speed, pulses, and height.

6. The laser ablation RFID antenna prototyping system of claim 5 wherein said power is greater than an ablation threshold, wherein said ablation threshold is when chemical bonds of said conductive ink begin to breakup.

7. The laser ablation RFID antenna prototype system of claim 6 wherein said power is less than a cutting threshold, wherein said cutting threshold is when said laser cuts through said substrate.

8. A laser ablation prototyping method for a radio frequency identification (RFID) antenna, comprising:
applying a conductive ink layer on a substrate;
formulating design parameters for an RFID antenna prototype; and
heating a portion of said conductive ink layer according to said design parameters with an ablation laser.

9. The method of claim 8 further comprising removing said portion of said conductive ink layer.

10. The method of claim 9 wherein said portion is removed with an adhesive surface.

11. The method of claim 9 wherein said portion is removed with a pressurized gas.

12. The method of claim 9 further comprising adjusting power and at least one of speed, pulses, and height to configure said ablation laser.

13. The method of claim 12 wherein said power is greater than an ablation threshold, wherein said ablation threshold is when chemical bonds of said conductive ink begin to breakup.

14. The method of claim 13 wherein said power is less than a cutting threshold, wherein said cutting threshold when said laser cuts through said substrate.

15. A laser ablation prototyping method for a radio frequency identification (RFID) antenna, comprising:
forming a conductive ink layer on a substrate;
formulating design parameters for a RFID antenna prototype;
configuring a power of an ablation laser, wherein said power is greater than an ablation threshold and less than a cutting threshold, wherein said ablation threshold is when chemical bonds of said conductive ink begin to breakup and said cutting threshold is when said laser cuts through said substrate;
applying said ablation laser to said conductive ink layer to heat portions of said conductive ink layer defined by said design parameters; and
removing said portions of said conductive ink layer from said substrate.

16. The method of claim 15 wherein said portions are removed with an adhesive surface.

17. The method of claim 15 wherein said portions are removed with a pressurized gas.

18. The method of claim 15 further comprising adjusting at least one of speed, pulses, and height to configure said ablation laser.
